(19) United States
(12) Patent Application Publication
(10) Pub. No.: US 2014/0321302 A1
(43) Pub. Date: Oct. 30, 2014

(54) MOBILE DEVICE AND METHOD FOR DATA SYNCHRONIZATION

(71) Applicant: HTC Corporation, Taoyuan County (TW)

(72) Inventors: Chen-Huang Fan, Taoyuan County (TW); Yu-Chuan Lai, Taoyuan County (TW); Po-Fei Chen, Taoyuan County (TW)

(73) Assignee: HTC Corporation, Taoyuan County (TW)

(21) Appl. No.: 14/197,233

(22) Filed: Mar. 5, 2014

Related U.S. Application Data
(60) Provisional application No. 61/816,171, filed on Apr. 26, 2013.

(51) Int. Cl. H04W 36/00

(52) U.S. Cl. CPC H04W 36/0083
USPC 370/252

(57) ABSTRACT

A mobile device is provided, which includes a modem processor and an application processor. The modem processor determines the channel quality between the mobile device and a wireless communication network. The modem processor calculates a counting value every time when determining the channel quality. The modem processor determines the overhead for data transmission between the mobile device and the wireless communication network according to the counting value. The modem processor determines the overhead to be low when the counting value reaches a preset value. The modem processor reduces the time for the counting value to reach the preset value when conducting a handover for the mobile device. The application processor allows or postpones a data synchronization started by an application with a server through the wireless communication network according to at least one preset condition. For example, one of the preset conditions is the aforementioned overhead.

### CROSS-REFERENCE TO RELATED APPLICATION

This application claims the priority benefits of U.S. provisional application Ser. No. 61/816,171, filed on Apr. 26, 2013. The entirety of the above-mentioned patent application is hereby incorporated by reference herein and made a part of this specification.

### BACKGROUND OF THE INVENTION

1. Field of the Invention

The present invention relates to a mobile device and a method for data synchronization. More particularly, the present invention relates to a mobile device and a method for adaptive data synchronization.

2. Description of the Related Art

A mobile device accesses Internet frequently by all kinds of applications running in background nowadays. For example, push email applications or instant message applications transfer or receive data through network connections between the mobile device and relevant servers periodically or when a specific event happens to synchronize the status and/or the data in both ends.

However, the data synchronization mentioned above may happen in areas with poor mobile signal condition. The application itself or the underlying operating system (OS) often spends time to retry data transmission under such poor condition even though the retry usually fails. This overhead leads to extra power consumption and increases the temperature of the mobile device.

### SUMMARY OF THE INVENTION

Accordingly, the present invention is directed to a mobile device and a method for data synchronization that provide the benefit of power saving and thermal mitigation for the mobile device by avoiding unsuccessful data transmission.

According to an embodiment of the present invention, a mobile device is provided, which includes a modem processor and an application processor. The modem processor determines the channel quality between the mobile device and a wireless communication network. The modem processor calculating a counting value every time when determining the channel quality. The modem processor determines the overhead for data transmission between the mobile device and the wireless communication network according to the counting value. The modem processor determines the overhead to be low when the counting value reaches a preset value. The modem processor reduces the time for the counting value to reach the preset value when conducting a handover for the mobile device. The application processor is coupled to the modem processor. The application processor executes an application. The application processor allows or postpones a data synchronization started by the application with a server through the wireless communication network according to at least one preset condition. For example, one of the preset conditions is the aforementioned overhead.

According to another embodiment of the present invention, a method for data synchronization is provided, which includes the following steps: determining the channel quality between a mobile device and a wireless communication network; calculating a counting value every time when determining the channel quality; determining the overhead for data transmission between the mobile device and the wireless communication network according to the counting value; determining the overhead to be low when the counting value reaches a preset value; reducing the time for the counting value to reach the preset value when conducting a handover for the mobile device; allowing or postponing a data synchronization started by an application with a server through the wireless communication network according to at least one preset condition. For example, one of the preset conditions is the aforementioned overhead.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a mobile device according to an embodiment of the present invention.

FIG. 2, FIG. 3 and FIG. 4 are flow charts showing a method for data synchronization according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

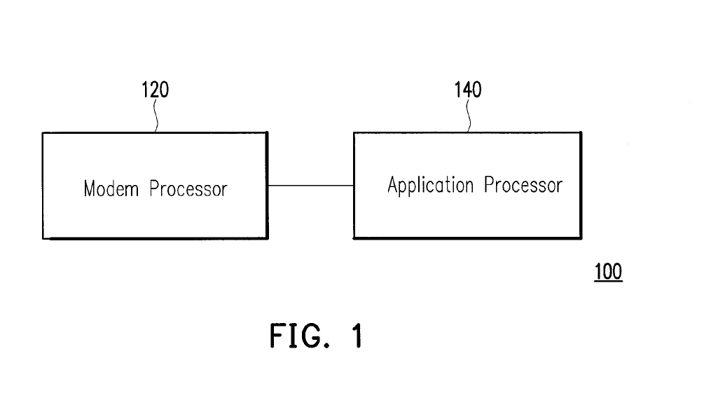

FIG. 1 is a schematic diagram showing a mobile device 100 according to an embodiment of the present invention. The mobile device 100 includes a modem processor 120 and an application processor 140. The application processor 140 is coupled to the modem processor 120.

The modem processor 120 modulates carrier signals of one or more wireless communication networks to encode digital information to be transmitted by the mobile device 100 and demodulates the carrier signals to decode digital information received by the mobile device 100. Moreover, the modem processor 120 is the communication interface between the mobile device 100 and the wireless communication networks. The wireless communication networks may be different types implemented based on different technologies or standards such as, but not limited to, General Packet Radio Service (GPRS), Universal Mobile Telecommunications System (UMTS), Long Term Evolution (LTE), Code Division Multiple Access (CDMA), High Speed Packet Access (HSPA), Worldwide Interoperability for Microwave Access (WiMAX), or WIFI.

The application processor 140 executes an operating system (OS) and one or more applications, such as push email applications and instant message applications. These applications may transfer or receive data through the wireless communication networks between the mobile device and relevant servers. Such data transmission is also known as data synchronization. Each application executed by the application processor 140 may start data synchronization with a remote server through a wireless communication network.

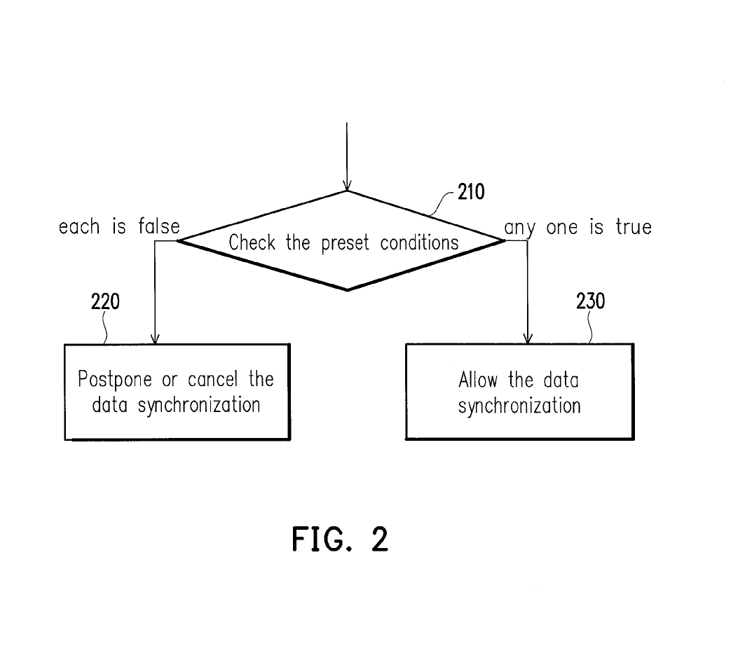

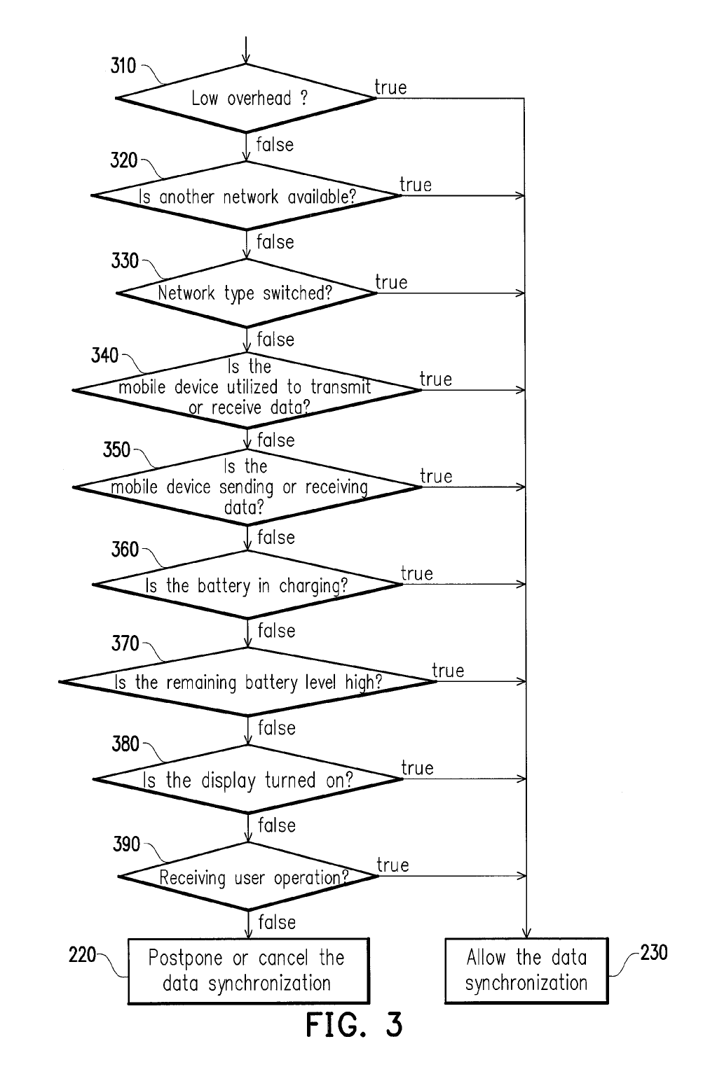

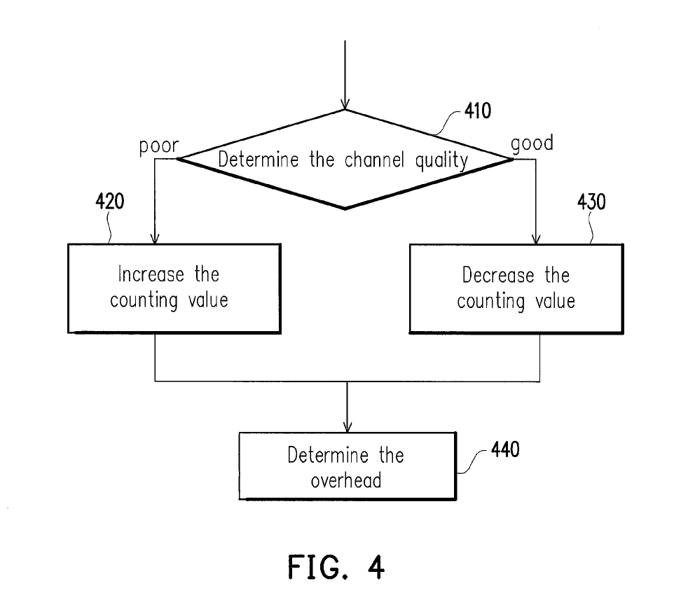

FIG. 2 is a flow chart showing a method for data synchronization executed by the mobile device 100 according to an embodiment of the present invention. At step 210, the modem processor 120 and/or the application processor 140 check one or more preset conditions. The preset conditions are based on calculated overhead of data transmission and/or operating status of the mobile device 100. When each preset condition is false, the application processor 140 postpones or cancels the data synchronization at step 220. When any one preset condition is true, the application processor 140 allows the data synchronization at step 230.

The entire flow in FIG. 2 may be executed every time an application starts data synchronization. Alternatively, step 210 may be executed periodically no matter there is the need for data synchronization or not. The result of the checking in step 210 may be recorded. Later, when an application starts data synchronization, the result may be checked to execute step 220 or 230.

FIG. 3 is a flow chart showing the details of step 210 according to an embodiment of the present invention. In this embodiment, step 210 includes steps 310-390. Each step of steps 310-390 checks an individual preset condition. Each preset condition in steps 310-390 may be determined to be true or false by either the modem processor 120 or the application processor 140.

In step 310, determine whether the overhead for data transmission between the mobile device 100 and the wireless communication network used by the data synchronization is low or not. Some of the details are shown later in FIG. 4. The flow proceeds to step 230 when the overhead is determined to be low, while the flow proceeds to step 320 when the overhead is determined to be high.

In step 320, check whether another wireless communication network is available for the data synchronization or not. For example, when the modem processor 120 currently uses an LTE network for data synchronization and a WIFI network is also available in good channel quality for data synchronization at the same time, the preset condition checked in step 320 is true and the flow proceeds to step 230. When the wireless communication network currently used by the modem processor 120 for data synchronization is the only one available in good channel quality, the preset condition checked in step 320 is false and the flow proceeds to step 330.

In step 330, check whether the modem processor 120 just switched (e.g. the switch is performed after the last check of the preset conditions in step 210) the connection for the data synchronization from a wireless communication network to another wireless communication network of a different type or not. For example, when the modem processor 120 uses a UMTS network for data synchronization and then switches to a WIFI network for the same data synchronization, the preset condition checked in step 330 is true and the flow proceeds to step 230. When the modem processor 120 keeps using the same wireless communication network for data synchronization, the preset condition checked in step 330 is false and the flow proceeds to step 340.

In step 340, check whether the mobile device 100 is utilized to transmit or receive data by another electronic device or not. For example, the mobile device 100 may be integrated with WIFI hotspot function so that other electronic devices may connect to the mobile device 100 through WIFI connection and access Internet through a connection between the mobile device 100 and the wireless communication network. When the mobile device 100 is utilized in this way, the preset condition checked in step 340 is true and the flow proceeds to step 230. Otherwise, the preset condition checked in step 340 is false and the flow proceeds to step 350.

In step 350, check whether or not the mobile device 100 is sending data or receiving data through a connection to the wireless communication network used by the data synchronization. The modem processor 120 may monitor the volume of data or the number of packets sent or received by the mobile device 100 through the connection to the wireless communication network used by the data synchronization in a preset period. When the volume of data or the number of packets in the preset period is larger than a threshold value, the preset condition checked in step 350 is true and the flow proceeds to step 230. Otherwise, the preset condition checked in step 350 is false and the flow proceeds to step 360.

In step 360, check whether the battery of the mobile device 100 is in charging or not. When the battery is in charging, there is no need to save power and the flow proceeds to step 230. When the battery is not in charging, the flow proceeds to step 370.

In step 370, check whether the remaining battery level of the mobile device 100 is higher than a preset threshold value or not. When the remaining battery level of the mobile device 100 is higher than the preset threshold value, there is no need to save power and the flow proceeds to step 230. Otherwise, the flow proceeds to step 380.

In step 380, check whether the display of the mobile device 100 is turned on or turned off. The display may be used to display images associated with the applications. When the display is turned on, the user may be paying attention to the data synchronization and the user experience should not be impacted by postponing or cancelling the data synchronization, therefore the flow proceeds to step 230. When the display is turned off, the flow proceeds to step 390.

In step 390, check whether the mobile device 100 is receiving user operation or not. The user operation may be any user activity such as input operation (e.g. button/key input) or touch operation. When the mobile device 100 is receiving user operation, the user may be paying attention to the data synchronization and therefore the flow proceeds to step 230. When the mobile device 100 is not receiving user operation, the flow proceeds to step 220.

One or more steps of steps 310-390 may be omitted in another embodiment of the present invention. The order of execution of steps 310-390 may be changed in another embodiment of the present invention.

FIG. 2 and FIG. 3 show that, when the overhead for data transmission is high and the operating status (steps 320-390) of the mobile device 100 is unsuitable for data synchronization, the data synchronization may be cancelled or postponed until the overhead or the operating status improves. In other words, the data synchronization may be dynamically and adaptively managed based on the calculated overhead and/or the checked operating status of the mobile device 100.

FIG. 4 is a flow chart showing the details of step 310 according to an embodiment of the present invention. The flow in FIG. 4 may be executed by the modem processor 120 or the application processor 140. In the present invention, the flow in FIG. 4 is preferably executed by the modem processor 120 since the modem processor 120 is the first tier communicating with the wireless communication network. As a result, without involving the application processor 140 (e.g. without waking up the application processor 140 from power saving state) the modem processor 120 is able to directly monitor a connection status of the wireless communication network such as channel quality.

At step 410, the modem processor 120 determines whether the channel quality between the mobile device 100 and the wireless communication network used by the data synchronization is good or poor according to the signal quality of the wireless communication network or the transmission power of the mobile device 100.

The signal quality may be represented by received signal strength indicator (RSSI), signal-to-noise ratio (SNR), or any other well-known criterion. The modem processor 120 may determine the channel quality to be good when the signal quality of the wireless communication network is higher than a preset threshold value T₁. Otherwise, the modem processor 120 may determine the channel quality to be poor.

Alternatively, the modem processor 120 may determine the channel quality to be good when the transmission power of the mobile device 100 is lower than a threshold value T₂. Otherwise, the modem processor 120 may determine the channel quality to be poor. Since poor channel quality requires higher transmission power of the mobile device 100, the channel quality is inversely proportional to the transmission power of the mobile device 100.

The modem processor 120 increases a counting value at step 420 every time when the channel quality is determined to be poor. One the other hand, the modem processor 120 decreases the counting value at step 430 every time when the channel quality is determined to be good. The counting value represents the overhead for data transmission that is determined in step 310. The higher the counting value, the higher the overhead. Please notice that in another embodiment the increasing or decreasing of the counting value could be reversely used for representing good channel quality and poor channel quality respectively.

Next, at step 440, the modem processor 120 determines whether the overhead for data transmission between the mobile device 100 and the wireless communication network is high or low according to the counting value. The overhead is determined to be high when the counting value is increased to a preset value P_{H} in step 420, while the overhead is determined to be low when the counting value is decreased to a preset value P_{L} in step 430.

The modem processor 120 may increase the counting value by a preset step value S_{U} at step 420. On the other hand, the modem processor 120 may decrease the counting value by a preset step value S_{D} at step 430. The values P_{H} and P_{L} may be any arbitrary preset integers. The values Sᵤ and S_{D} may be any arbitrary preset positive integers. For example, P_{H} may be 50, P_{L} may be 0, S_{U} may be 2, and S_{D} may be 2. The initial counting value may be any preset integer no smaller than P_{L} and no larger than P_{H}.

Sometimes the cell handover of the wireless communication network might occur in the mobile device when the mobile device moves from one area to another area. The operation of steps 410-440 mentioned above is more suitable for the situation when no handover associated with the wireless communication network is conducted for the mobile device 100. When such a handover occurs, the modem processor 120 may assume the channel quality will improve in another cell or service area and adjusts the counting value aggressively. For example, when the modem processor 120 conducts a handover for the mobile device 100 and the counting value is larger than a preset value P_{A}, the modem processor 120 may set the counting value to be the value P_{A}. The preset value P_{A} is smaller than the preset value P_{H} in order to reduce the time for the counting value to reach the preset value P_{L}.

Alternatively, when the modem processor 120 conducts the handover for the mobile device 100, the modem processor 120 may set the step value S_{D} to be a larger value in order to reduce the time for the counting value to reach the preset value P_{L}. For example, S_{D} may be 2 when there is no handover, while S_{D} may be set to be 5 or 10 temporarily when the handover occurs.

The application processor 140 may sleep to save power while the modem processor 120 monitors the aforementioned overhead for data transmission. The modem processor 120 may awake the application processor 140 by an interrupt when the overhead is determined to be low so that the application processor 140 may execute step 230 at the right moment.

When the application processor 140 executes step 220, the application processor 140 may postpone or cancel the initial attempt of the data synchronization, or a later retry of the same data synchronization. When an application starts data synchronization, the application may send a corresponding request, event or message to the OS. In the case that the application processor 140 postpones the initial attempt of the data synchronization, the application processor 140 may put the request, event or message into a waiting queue until the application processor 140 allows the data synchronization in step 230. In the case that the application processor 140 cancels the initial attempt of the data synchronization, the application processor 140 may simply delete or discard the request, event or message or return a response of failure or error back to the application.

In the cases that the application processor 140 postpones or cancels the later retry of the data synchronization, the application processor 140 does not block the initial attempt of the data synchronization. The initial attempt of the data synchronization is performed normally. However, the initial attempt of the data synchronization may fail due to network timeout or other causes. Accordingly, the OS or the application may start a timer to remind the application to retry the data synchronization later. In the cases that the application processor 140 postpones the later retry of the data synchronization, the application processor 140 may delay or suspend the timer until the application processor 140 allows the data synchronization in step 230. In the cases that the application processor 140 cancels the later retry of the data synchronization, the application processor 140 may let the timer expire and then return a result of failure or error in response to the later retry of the data synchronization.

By this invention, when overhead of data transmission detected by the mobile device is high and certain pre-defined criteria are matched, the data synchronization between the mobile device and the relevant server is postponed or cancelled. As a result, the power is saved and the temperature of the mobile device is lowered since the mobile device will not spend time and energy for those unsuccessful retries of data synchronization.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile device, comprising:
a modem processor, determining a channel quality between the mobile device and a wireless communication network, calculating a counting value every time when determining the channel quality, determining an overhead for data transmission between the mobile device and the wireless communication network according to the counting value, determining the overhead to be low when the counting value reaches a first preset value, and reducing time for the counting value to reach the first preset value when conducting a handover for the mobile device; and
an application processor, coupled to the modem processor, executing an application, allowing or postponing a data synchronization started by the application with a server through the wireless communication network according to at least one preset condition, wherein one said preset condition is the overhead.

2. The mobile device of claim 1, wherein the channel quality is determined to be good when a signal quality of the wireless communication network is higher than a first threshold value or when a transmission power of the mobile device is lower than a second threshold value, and wherein the channel quality is determined to be poor when the signal quality of the wireless communication network is lower than the first threshold value or when the transmission power of the mobile device is higher than the second threshold value.

3. The mobile device of claim 1, wherein the modem processor increases the counting value every time when the channel quality is determined to be poor and the modem processor decreases the counting value every time when the channel quality is determined to be good.

4. The mobile device of claim 1, wherein the overhead is determined to be high when the counting value is increased to a second preset value, and wherein the overhead is determined to be low when the counting value is decreased to the first preset value.

5. The mobile device of claim 4, wherein when the modem processor conducts the handover for the mobile device and the counting value is larger than a third preset value, the modem processor sets the counting value to be the third preset value, wherein the third preset value is smaller than the second preset value.

6. The mobile device of claim 4, wherein when the modem processor does not conduct the handover for the mobile device, the modem processor decreases the counting value by a first step value every time when the channel quality is determined to be good, and wherein when the modem processor conducts the handover for the mobile device, the modem processor decreases the counting value by a second step value every time when the channel quality is determined to be good, and wherein the second step value is larger than the first step value.

7. The mobile device of claim 1, wherein the application processor sleeps while the modem processor monitors the overhead and the modem processor awakes the application processor by an interrupt when the overhead is determined to be low.

8. The mobile device of claim 1, wherein one said preset condition is that another wireless communication network is available in good channel quality for the data synchronization or the modem processor switches a connection for the data synchronization from the wireless communication network to the another wireless communication network, wherein the wireless communication network and the another wireless communication network are of different types.

9. The mobile device of claim 1, wherein one said preset condition is that the mobile device is utilized to transmit or receive data by another electronic device.

10. The mobile device of claim 1, wherein one said preset condition is that a volume of data or a number of packets sent or received by the mobile device through a connection to the wireless communication network in a preset period is larger than a threshold value.

11. The mobile device of claim 1, wherein one said preset condition is that a battery of the mobile device is in charging or a remaining battery level of the mobile device is higher than a threshold value.

12. The mobile device of claim 1, wherein one said preset condition is that a display of the mobile device is turned on or the mobile device is receiving user operation.

13. A method for data synchronization, comprising:
determining a channel quality between a mobile device and a wireless communication network;
calculating a counting value every time when determining the channel quality;
determining an overhead for data transmission between the mobile device and the wireless communication network according to the counting value;
determining the overhead to be low when the counting value reaches a first preset value;
reducing time for the counting value to reach the first preset value when conducting a handover for the mobile device; and
allowing or postponing a data synchronization started by an application with a server through the wireless communication network according to at least one preset condition, wherein one said preset condition is the overhead.

14. The method of claim 13, wherein the channel quality is determined to be good when a signal quality of the wireless communication network is higher than a first threshold value or when a transmission power of the mobile device is lower than a second threshold value, and wherein the channel quality is determined to be poor when the signal quality of the wireless communication network is lower than the first threshold value or when the transmission power of the mobile device is higher than the second threshold value.

15. The method of claim 13, wherein the step of calculating the counting value comprises:
increasing the counting value every time when the channel quality is determined to be poor; and
decreasing the counting value every time when the channel quality is determined to be good.

16. The method of claim 13, wherein the overhead is determined to be high when the counting value is increased to a second preset value, and wherein the overhead is determined to be low when the counting value is decreased to the first preset value.

17. The method of claim 16, wherein when the handover is conducted for the mobile device and the counting value is larger than a third preset value, the method further comprising:
setting the counting value to be the third preset value, wherein the third preset value is smaller than the second preset value.

18. The method of claim 16, wherein when no handover is conducted for the mobile device, the method further comprises decreasing the counting value by a first step value every time when the channel quality is determined to be good, and wherein when the handover is conducted for the mobile device, the method further comprises decreasing the counting value by a second step value every time when the channel quality is determined to be good, and wherein the second step value is larger than the first step value.

19. The method of claim 13, wherein one said preset condition is that another wireless communication network is available in good channel quality for the data synchronization or a connection for the data synchronization is switched from the wireless communication network to the another wireless communication network, wherein the wireless communication network and the another wireless communication network are of different types.

20. The method of claim 13, wherein one said preset condition is that the mobile device is utilized to transmit or receive data by another electronic device.

21. The method of claim 13, wherein one said preset condition is that a volume of data or a number of packets sent or received by the mobile device through a connection to the wireless communication network in a preset period is larger than a threshold value.

22. The method of claim 13, wherein one said preset condition is that a battery of the mobile device is in charging or a remaining battery level of the mobile device is higher than a threshold value.

23. The method of claim 13, wherein one said preset condition is that a display of the mobile device is turned on or the mobile device is receiving user operation.
